(19) United States
(12) Patent Application Publication
(10) Pub. No.: US 2025/0242637 A1
(43) Pub. Date: Jul. 31, 2025

(54) TIRE HAVING A REGROOVABLE TREAD

(71) Applicant: COMPAGNIE GENERALE DES ETABLISSEMENTS MICHELIN, Clermont-Ferrand (FR)

(72) Inventors: PATRICK DAYET, Clermont-Ferrand (FR); LUC BESTGEN, Clermont-Ferrand (FR); BAPTISTE THIEL, Clermont-Ferrand (FR)

(21) Appl. No.: 18/854,223

(22) PCT Filed: Mar. 21, 2023
(86) PCT No.: PCT/EP2023/057206

§ 371 Date: Oct. 4, 2024

(30) Foreign Application Priority Data
Apr. 5, 2022 (FR) 2203108

(51) Int. Cl. B60C 11/12; B60C 11/03

(52) U.S. Cl. CPC B60C 11/1259; B60C 11/0306; B60C 2011/0355

(57) ABSTRACT

A tire (1) can be regrooved at least once and the tread of which has at least one re-cuttable groove (3) and at least one sipe (8). The height (Hᵢ) of the at least one sipe (8) of the tire when new is greater than the groove height (H_{N3}) of the at least one re-cuttable groove (3) of the tire when new and after the groove has been re-cut, the height (H_{R}) of the at least one re-cut groove is greater than or equal to 70% of the groove height (H_{N3}) of the at least one re-cuttable groove of the tire when new.

The present invention relates to a tire having a radial carcass reinforcement, and more particularly to a tire intended to be fitted to vehicles that bear heavy loads, such as lorries, tractors, trailers or buses, for example.

In general, in tires of the heavy-duty type, the carcass reinforcement is anchored on either side in the region of the bead and is radially surmounted by a crown reinforcement made up of at least two layers that are superposed and formed of threads or cords, which are parallel in each layer and are crossed from one layer to the next, forming angles of between 10° and 45° with the circumferential direction. Said working layers, that form the working reinforcement, can also be covered with at least one layer, called protective layer, formed of reinforcing elements, called elastic reinforcing elements, that are advantageously metal and extensible. It may also comprise a layer of metal threads or cords of low extensibility that form an angle of between 45° and 90° with the circumferential direction, this ply, referred to as triangulation ply, being situated radially between the carcass reinforcement and the first crown ply, referred to as working ply, which are formed of parallel threads or cords that exhibit angles at most equal to 45° in terms of absolute value. The triangulation ply forms, with at least said working ply, a triangulated reinforcement, which exhibits little deformation under the various stresses to which it is subjected, the triangulation ply essentially serving to absorb the transverse compressive forces that act on all the reinforcing elements in the crown region of the tire.

Cords are said to be inextensible when said cords exhibit, under a tensile force equal to 10% of the breaking force, a relative elongation at most equal to 0.2%.

Cords are said to be elastic when said cords exhibit, under a tensile force equal to the breaking load, a relative elongation at least equal to 3% with a maximum tangent modulus of less than 150 GPa.

The circumferential direction of the tire, or longitudinal direction, is the direction tangential to the periphery of the tire and defined by the direction of running of the tire.

The axis of rotation of the tire is the axis about which it turns in normal use.

A radial or meridian plane is a plane that contains the axis of rotation of the tire.

The circumferential median plane, or equatorial plane, is a plane that is perpendicular to the axis of rotation of the tire and divides the tire into two halves.

The transverse or axial direction of the tire is parallel to the axis of rotation of the tire. An axial distance is measured in the axial direction. The expression “axially on the inside of or axially on the outside of, respectively” means “the axial distance of which, measured from the equatorial plane, is less than or greater than, respectively”.

The radial direction is a direction that intersects the axis of rotation of the tire and is perpendicular thereto. A radial distance is measured in the radial direction. The expression “radially on the inside of or radially on the outside of, respectively” means “the radial distance of which, measured from the axis of rotation of the tire, is less than or greater than, respectively”.

Radially on the outside of the crown reinforcement is the tread, usually made up of polymeric materials intended to come into contact with the ground in the contact patch in which the tire makes contact with the ground.

It is known to provide the tread, which is to say that part of the tire that is intended to come into contact with the ground, and to become worn, when the tire is running, with a tread pattern formed of raised elements delimited by cuts such as grooves, which have a circumferential, transverse or oblique orientation. The aim of such a tread pattern is to give the tread good performance properties when running on dry road surfaces and on road surfaces covered with water, especially when it is raining.

In order to improve the performance of the treads without however reducing the shear stiffnesses of said treads too much, it is known practice to form, on the tread surface, a plurality of transversely or obliquely oriented edge corners in order to bite into the film of water on a road surface in order to ensure good contact between the tread and the road surface. One means of obtaining such edge corners consists in providing the tread with a plurality of cuts, these cuts having the form of grooves or the form of sipes. A distinction is made, in the present application, between sipes and grooves in that sipes have a width suitable for allowing, during running, at least partial contact between the facing walls delimiting these sipes and in particular when they are in the contact patch in contact with the ground, which would not be the case for grooves under normal conditions of use of the tire.

For the purposes of the invention, a cut generically denotes either a groove or a sipe and corresponds to the space delimited by walls of material that face one another and are at a non-zero distance from one another (referred to as the “width of the cut”). It is precisely this distance that distinguishes a sipe from a groove; in the case of a sipe, this distance is suitable for allowing the opposing walls that delimit said sipe to come into at least partial contact at least when they enter the contact patch in contact with the road surface. In the case of a groove, the walls of this groove cannot come into contact with one another under usual running conditions.

For the purposes of the invention, a longitudinally oriented cut is a cut in which the mean plane of at least a portion of the walls of said cut forms an angle of less than 10° with a longitudinal plane. This angle formed with a longitudinal plane may be oriented in one direction or the other relative to said longitudinal plane. A longitudinally oriented cut may also be a cut of which the walls undulate or zig-zag about a mean plane as has just been described.

For the purposes of the invention, a transversely oriented cut is a cut in which the mean plane of at least a portion of the walls of said cut forms an angle of less than 35° with a radial plane. This angle formed with a radial plane may be oriented in one direction or the other relative to said radial plane. A transversely oriented cut may also be a cut of which the walls undulate or zig-zag about a mean plane as has just been described.

For the purposes of the invention, an obliquely oriented cut is a cut in which the mean plane of at least a portion of the walls of said cut forms an angle of between 35° and 80° with a radial plane. This angle formed with a radial plane may be oriented in one direction or the other relative to said radial plane. An obliquely oriented cut may also be a cut of which the walls undulate or zig-zag about a mean plane as has just been described.

Combined with this requirement to improve the grip performance by the presence of edge corners formed by the transverse cuts, it is also required that the performance properties of a tread be durable, which is to say that satisfactory performance properties are achieved even after more or less advanced partial wear. Partial wear of a tread is intended to mean a state of wear corresponding to a tread thickness at most equal to the total tread thickness able to be worn before having to change the tire, especially for regulatory reasons.

The grooves generally comprise tread-wear indicators, which are small platforms formed in the vulcanized rubber compound and covering the bottoms of these grooves over a certain circumferential length, these tread-wear indicators indicating the minimum depth of tread pattern that must legally remain on the tread in use.

The tread patterns for heavy-duty vehicles may be regroovable (regrooving being an operation whereby new grooves are cut) and tires that have such tread patterns bear the word “Regroovable” or the symbol “U” on their sidewall. Regrooving makes it possible on the one hand to extend the grip potential of the heavy-duty tire and, on the other hand, to significantly increase the distance over which it is able to be run.

The regrooving of heavy-duty tires is a usual operation that is authorized for the sake of safety and for the increase in cost-effectiveness that it affords. By way of example, it is explicitly permitted by the French highway code (Code de la Route Article 4 of the decree of Oct. 24, 1994) and recommended by the ETRTO and by AFNOR (standard NFR12714). For the purposes of this operation, the manufacturers are required to provide regrooving diagrams that the regrooving technicians are obliged to follow.

The groove heights on a new tire can be measured and the groove heights after regrooving can be deduced from these regrooving diagrams.

As is known per se, a groove can be re-cut using a heated rounded blade, which is still often manipulated by a human operator. Said blade, connected to a frame that bears against the tread surface, can be used by hand so as to follow the line of the groove on the tread surface fairly faithfully, even when the line of the groove is not rectilinear.

Regrooving makes it possible to restore sharp edge corners and is usually intended to restore a tread-pattern height that corresponds to that of a heavy-duty tire at the mid-wear point. The usual recommendations aim for a height, after regrooving, of 5 to 6 mm made up of a re-cut groove of 3 to 4 mm and of 2 mm of remaining height; in practice, regrooving is often performed earlier than this with remaining heights of between 4 and 5 mm, leading to a height, after regrooving, of 7 to 9 mm for as-new tire tread pattern heights comprised between 12 and 20 mm.

Regrooving a tire offers a number of advantages. First of all, by restoring the tread-pattern height of the tire, regrooving makes it possible to extend the life of the tire.

Further, because the regrooving is performed when the tread thickness is at its smallest and therefore when the tire is exhibiting its lowest rolling resistance, the distance over which the tire can be run is extended when the rolling resistance is at its lowest.

The inventors have set themselves the task of being able to provide tires exhibiting even better performance in terms of rolling resistance while at the same time maintaining ever greater running distances and good properties of grip on wet ground.

This aim has been achieved by a tire which can be regrooved at least once, comprising a crown reinforcement, itself radially capped by a tread, which is made of at least one elastomeric compound and is joined to two beads via two sidewalls, said tread having at least one re-cuttable groove forming at least one tread pattern element making up the tread pattern of the tire, exhibiting a height between the bottom of said at least one groove and the tread surface when the tire is new, and at least one sipe, flush with the tread surface when the tire is new, exhibiting a height between the bottom of said at least one sipe and the tread surface when the tire is new, the height of said at least one sipe of the tire when new being greater than the groove height of said at least one re-cuttable groove of the tire when new. After the groove has been re-cut, the height of said at least one re-cut groove is greater than or equal to 70% of the groove height of said at least one re-cuttable groove of the tire when new.

Said at least one sipe advantageously has a transverse or oblique orientation.

For the purposes of the invention, the groove height and the sipe height are measured in a meridian section of the tire and correspond to the distance measured between the radially outer surface of the tread, which forms the surface in contact with the ground and is extrapolated in order to disregard the cuts, and the surface of the bottoms of the tread pattern, said distance being measured in a direction normal to the radially outer surface of the tread. The bottoms of the tread pattern are the radially innermost points of the recessed zones of the tread, disregarding the presence of elements such as tread-wear indicators, wells indicating regrooving depth, or any other element the sum of the surface areas of which represents less than 15% of the total area of the cut.

The sipe height of said at least one sipe of the tire when new is thus measured on a new tire.

The groove height of said at least one re-cuttable groove of the tire when new is also measured on a new tire. The height of said at least one re-cut groove may likewise be measured when the tire is regrooved; the height of said at least one re-cut groove may also be determined in the way explained hereinabove from the new tire and from the regrooving diagram supplied by the manufacturer.

Advantageously according to the invention, the height corresponding to the distance between the tread surface when new and the bottom of the grooves after the last regrooving operation is greater than or equal to 200% of the height between the bottom of the groove and the tread surface when the tire is new. More advantageously, the height corresponding to the distance between the tread surface when new and the bottom of the grooves after the last regrooving operation is greater than or equal to 250% of the height between the bottom of the groove and the tread surface when the tire is new.

The height corresponding to the distance between the tread surface when new and the bottom of the grooves after the last regrooving operation may be determined when the tire is regrooved or else may also be determined in the way explained hereinabove from the new tire and from the regrooving diagram supplied by the manufacturer.

According to a preferred embodiment of the invention, the height of said at least one sipe of the tire when new is greater than 90% of the height corresponding to the distance between the tread surface when new and the bottom of said at least one groove after the last regrooving operation.

More preferably still, the height of said at least one sipe of the tire when new is equal to the height corresponding to the distance between the tread surface when new and the bottom of the grooves after the last regrooving operation.

Tests conducted on tires according to the invention have demonstrated that, by comparison with usual regroovable tires, the performance in terms of rolling resistance is improved while at the same time maintaining similar properties of grip on wet ground and for substantially identical running distances that can be covered before the tire becomes completely worn.

The inventors have first of all been able to demonstrate that the combination of a tread thickness substantially identical to that of a tire of more conventional design and new-tire groove heights that are reduced in comparison with those of a tire of more conventional design makes it possible to significantly improve the performance in terms of rolling resistance.

Specifically, for tread thicknesses similar to those of tires of more traditional design, having groove heights after regrooving that are greater than 70% of the groove height when new signifies that the groove height when new is reduced by comparison with that of the tires of more conventional design.

As stated previously, the regrooving intended for tires of more conventional design leads to groove heights that are less than half the height of the grooves when new. According to the invention, for a given tread thickness, the regrooving of the tread therefore probably needs to be performed earlier, which is to say for a lower degree of tread wear than is the case with a tire of more conventional design.

The inventors have thus been able to demonstrate that this early regrooving of the tread of the tire according to the invention makes it possible to improve its performance in terms of rolling resistance appreciably throughout its life and in particular during the running phase before regrooving.

The presence of the sipes over a depth greater than that of the initial grooves and advantageously equal to the height corresponding to the distance between the tread surface when new and the bottom of said at least one groove after the last regrooving operation makes it possible to keep these sipes after the first regrooving operation and advantageously until the tread has become completely worn after the last regrooving operation. The performance in terms of grip is thus optimized throughout the life of the tire.

Conventional tire designs, in the case of which the grooves have a greater depth than those of the tires according to the invention when new, have sipes of which the depth usually does not exceed the depth of said grooves. The presence of such grooves decreases the overall stiffness of the tread and makes it easier for the sipes to open up; if the sipes have a greater depth than the grooves do, this would result in these sipes opening up to an even greater extent and would increase the risk of penetration of small stones that can damage the bottoms of the sipes and prevent any regrooving. In addition, the production of sipes that have a greater depth than the depth of the grooves contributes to increasing the flexibility of the tread and thus further enhances this risk of stones penetrating.

The inventors have also been able to demonstrate that the group according to the invention of sipes that have a greater depth than that of the grooves, said grooves having a depth when new which is reduced by comparison with those of tires of more conventional design, makes it possible to prevent small stones from possibly penetrating said grooves when the tire is running. This is because the increase in stiffness of the tread owing to grooves that have small depths by comparison with more conventional designs permits the production of sipes which have a depth that goes beyond that of the grooves without the sipes opening up to too great an extent when the tire is running such that small stones can become lodged between the walls of said sipes. Moreover, this increase in stiffness of the tread compared to more conventional designs compensates for the greater flexibility that can be conferred by sipes of greater depth, including when these sipes are provided with a depth equal to the height corresponding to the distance between the tread surface when new and the bottom of said at least one groove after the last regrooving operation.

The increase in stiffness of the tread compared to more conventional designs owing to grooves of small depths by comparison with these more conventional designs also permits the number of sipes on the tread to be increased compared to said more conventional designs. The inventors have been able to demonstrate that the increase in stiffness of the tread obtained according to the invention with grooves of smaller depth when new, by comparison with tires of more conventional design, makes it possible to compensate both for the greater flexibility owing to deeper sipes and the greater flexibility of a higher number of sipes.

According to a first embodiment of the invention, said at least one re-cuttable groove is circumferential.

According to a second embodiment of the invention, said at least one re-cuttable groove is transverse.

According to a third embodiment of the invention, said at least one re-cuttable groove is oblique.

According to other embodiments of the invention, the tire has a combination of circumferential and/or transverse and/or oblique re-cuttable grooves.

Whether they all have the same orientation or have multiple orientations, the invention advantageously intends for all of the grooves of the tire to be re-cut according to the invention during the one same step.

A preferred variant of the invention combines circumferential grooves with transverse and/or oblique sipes. When all of the grooves can be re-cut according to the invention, and when all of the sipes have a height equal to the height corresponding to the distance between the tread surface when new and the bottom of the grooves after the last regrooving operation, the tread pattern of the tire can be substantially identical to the surface of the tread throughout the life of the tire, including after regrooving.

According to an advantageous embodiment of the invention, the ends of said at least one sipe each emerge in a well which itself emerges in the surface of the tread, said wells having a height at least equal to the height of said at least one sipe.

The cross section of the well in the surface of the tread is advantageously circular, but it may have any shape. The cross section is also advantageously variable in terms of depth to indicate a regrooving step. For example, such a well may be made up of multiple cylinders of which the cross-sectional diameter decreases with depth, two cylinders being connected by a surface substantially parallel to the surface of the tread. This surface may give an indication of the regrooving limit.

Besides this type of associated function, such a well corresponds to the recessed part in the tread of a solid mold shape which is associated with the sipe blade of the mold that makes it possible to create the sipe. These two solid shapes with a dimension substantially greater than the thickness of the sipe blade make the sipe blade stiffer and make it possible to avoid risks of breakage while the tread of the tire is being molded.

According to one variant embodiment of the invention, said at least one sipe connects two grooves.

According to this variant embodiment, and if there are wells at each of the ends, these wells are visible in a groove. If these wells have a circular cross section, it is then possible for only a semi-circle forming a protrusion of the groove to remain in the surface of the tread.

According to such a configuration, the inventors also advantageously intend to place tread-wear indicators in these protrusions formed by the wells so as to best allow fluids to flow in the grooves, said tread-wear indicators needing to be disposed in these grooves.

According to an advantageous variant of the invention, after regrooving, the height of said at least one re-cut groove is greater than or equal to 85% of the height of said at least one re-cuttable groove of the tire when new, and more preferably still is greater than 95% of the tread-pattern height of the tire when new.

According to one embodiment of the invention, at least one groove can be re-cut at least twice. According to this embodiment, it may even be possible to increase the performance in terms of rolling resistance by providing groove depths when new which are even smaller while still meeting performance requirements in terms of grip on wet ground.

According to this embodiment and in the case of several grooves with the same orientation or else with multiple orientations, the invention advantageously provides for all of the grooves of the tire to be re-cut simultaneously during each regrooving operation.

More advantageously, according to this embodiment of the invention, the elastomer compound regrooved during the first regrooving operation is different from the elastomer compound regrooved during the second regrooving operation. For example, the radially innermost elastomer compound contains no black filler, so that a color contrast is exhibited when this compound appears at the time of the first regrooving operation. Such an arrangement may notably make the regrooving steps easier.

According to other embodiments of the invention, in particular if the sipes do not emerge in the wells, the tread comprises depth indicators in the form, for example, of wells or incisions of small non-zero width placed in the bottom of the groove either parallel to the direction of said groove or perpendicular to said direction, or both simultaneously, the means of indicating the minimum and maximum depths then being the geometric shape of the bottom of the depth-indicating incision.

Advantageously according to the invention, the regroovable elastomer compound is different from at least part of the elastomer compound that constitutes the tread. Such an embodiment may be obtained by coextrusion of the compounds during the preparation of the semi-finished product or products intended to at least partially form the tread.

Either the one or the other of the embodiments of the invention set out hereinabove may also be associated with the creation of a complex tread consisting for example of at least two radially superposed layers of elastomer compound.

According to one embodiment of the invention, the crown reinforcement of the tire is formed of at least two working crown layers of inextensible reinforcing elements that are crossed from one layer to the other, forming angles of between 10° and 45° with the circumferential direction.

According to other embodiments of the invention, the crown reinforcement also comprises at least one layer of circumferential reinforcing elements.

One embodiment of the invention also makes provision for the crown reinforcement to be supplemented radially on the outside by at least one additional layer, called protective layer, of reinforcing elements, called elastic reinforcing elements, oriented relative to the circumferential direction with an angle of between 10° and 45° and in the same direction as the angle formed by the inextensible elements of the working layer that is radially adjacent thereto.

According to any one of the embodiments of the invention mentioned above, the crown reinforcement may also be supplemented, radially on the inside between the carcass reinforcement and the radially inner working layer closest to said carcass reinforcement, by a triangulation layer of inextensible metal reinforcing elements made of steel forming, with the circumferential direction, an angle greater than 60° and in the same direction as that of the angle formed by the reinforcing elements of the layer radially closest to the carcass reinforcement.

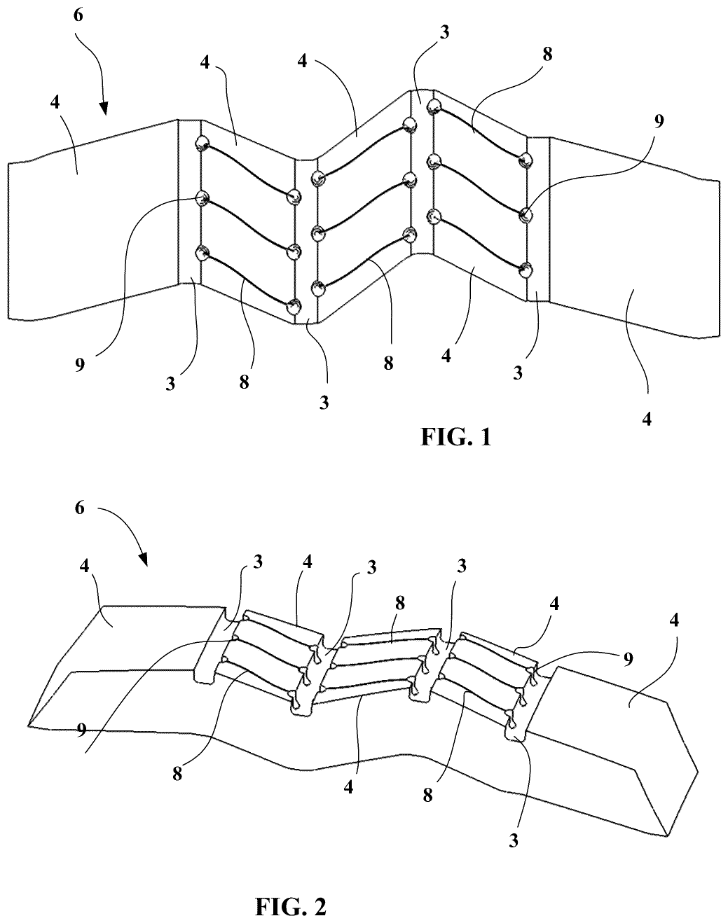

Further details and advantageous features of the invention will become apparent hereinafter from the description of exemplary embodiments of the invention, with reference to FIGS. 1 to 7 in which:

FIG. 1 shows a schematic top view of a part of a tread of a tire according to the invention,

FIG. 2 shows a schematic perspective view of a part of a tread of a tire according to the invention,

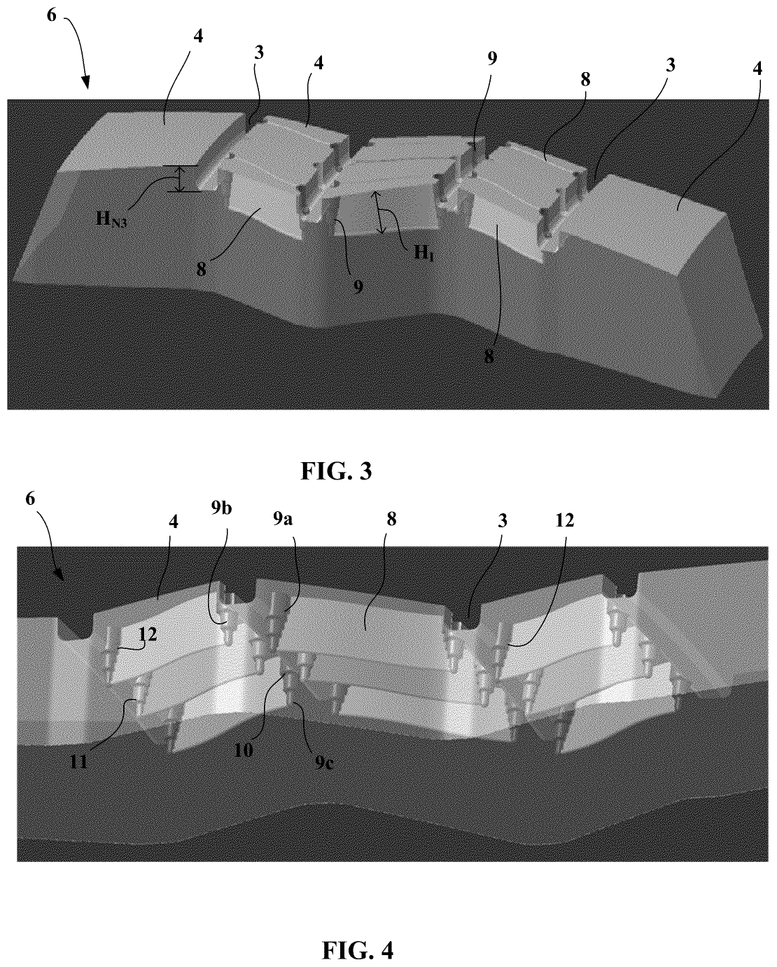

FIG. 3 shows a schematic perspective view, in section along the line of the sipes, of a part of a tread of a tire according to the invention,

FIG. 4 shows a schematic see-through perspective view of a part of a tread of a tire according to the invention,

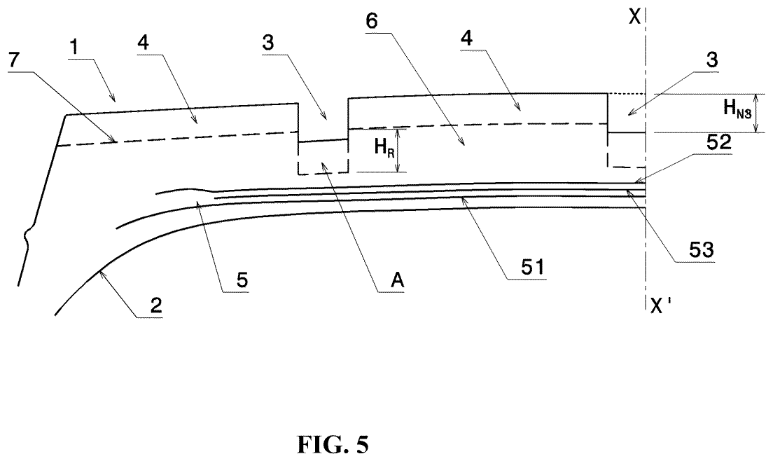

FIG. 5 shows a schematic meridian view of a tire according to a first exemplary embodiment of the invention,

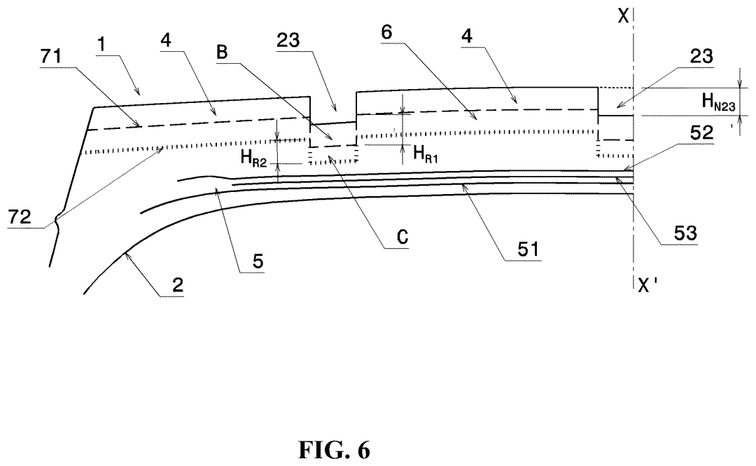

FIG. 6 is a schematic meridian view of a tire according to a second exemplary embodiment of the invention,

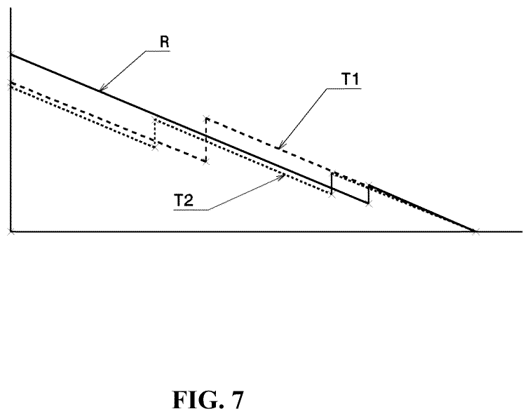

FIG. 7 is a schematic depiction of the rolling resistance of a tire as it wears, for a reference tire and for two tires according to the invention.

In order to make them easier to understand, FIGS. 1 to 6 are not drawn to scale.

These FIGS. 1 to 6 depict a tire 1, of size 315/70R22.5.

FIG. 1 illustrates a partial top view of a part of the tread 6 of a tire 1. The tread 6 has circumferential grooves 3 which separate ribs or ridges 4. The grooves 3 are connected to one another by sipes 8.

In FIG. 1, the sipes are oriented in a transverse or oblique overall direction. In fact, they undulate about this overall direction so as to make the sipe blades of the mold that will make it possible to produce these sipes stiffer.

As explained above, the sipes 8 emerge at each of their ends in wells 9, which correspond to solid elements positioned at the ends of the sipe blades in the mold to stiffen them.

FIG. 2 illustrates a perspective partial view of this same part of the tread 6 of a tire 1.

FIG. 3 illustrates a schematic perspective partial view, in section along the line of the sipes, of the part of the tread 6 of a tire 1. There are circumferential grooves 3 separating the ribs or ridges 4. The grooves 3 have a height H_{N3}. The grooves 3 are connected to one another by sipes 8 of which the height Hᵢ is greater than the height H_{N3} of the grooves 3. This height Hᵢ of the sipes 8 is equal to the height corresponding to the distance between the tread surface when new and the bottom of a groove 3 after the last regrooving operation.

FIG. 4 illustrates a schematic see-through partial view of the part of the tread 6 of a tire 1.

FIG. 4 makes it clearer to see that the wells 9 are realized by a stack of three cylinders 9a, 9b, 9c, the diameters of which decrease with increasing depth in the tire. These cylinders 9a, 9b, 9c are connected to one another by flat surfaces 10, 11. The flat surface 10 marks a limit for the first intended regrooving operation, as explained above, and the surface 11 marks a limit for the second regrooving operation. The three cylinders 9a, 9b, 9c correspond to the case in FIG. 6, intending two regrooving operations.

Since the sipes 8 connect the grooves 3, the cylinders are partially formed in the grooves 3 and the radially outermost cylinder 9a is thus provided with just a half-section formed in the tread, the other half being in the groove and therefore absent. This radially outermost first cylinder 9a is advantageously intended to create a flat surface 10 for connection to the next cylinder so that a tread-wear indicator 12 can be placed there, thus completely freeing up the volume of the grooves 3, as mentioned above.

FIGS. 5 and 6 show only a half-view of a tire 1, which extends symmetrically with respect to the axis XX′, which represents the circumferential median plane, or equatorial plane, of the tire 1.

In FIGS. 5 and 6, the tire 1 comprises a radial carcass reinforcement 2 anchored in two beads, around bead wires, which are not shown. The carcass reinforcement 2 is formed of a single layer of metal cords. The carcass reinforcement 2 is hooped by a crown reinforcement 5, itself capped by a tread 6. The tread has three grooves 3 forming four ribs or ridges 4. In order to make them easier to understand, FIGS. 5 and 6 do not show the transverse or oblique sipes.

The lower sidewall regions and the beads of the tire 1 are in particular not depicted in the figures.

In FIGS. 5 and 6, the crown reinforcement 5 is formed radially from the inside to the outside:
of a first working layer 51 formed of inextensible metal cords which are continuous across the entire width of the ply and oriented at an angle of 16° with the circumferential direction,
of a layer of circumferential reinforcing elements 53, formed of 21.23 elastic metal cords made of steel, with a pitch spacing of 2 mm, and
of a second working layer 52 formed of inextensible metal cords which are continuous across the entire width of the ply, oriented at an angle 30° with the circumferential direction, and crossed with the metal cords of the first working layer.

The axial width L₅₁ of the first working layer 51 is equal to 246 mm.

The axial width L₅₂ of the second working layer 52 is equal to 228 mm.

The axial width L₅₃ of the layer of circumferential reinforcing elements 53 is itself equal to 200 mm.

In FIG. 5, according to the invention, the grooves 3 are of the re-cuttable type. As illustrated in FIG. 5, the grooves 3 consist of a single layer A forming the bottoms of the grooves when new and corresponding to a single regrooving operation.

The height H_{N3} of the grooves 3 when the tire is new is equal to 7.5 mm.

The height H_{R} of the grooves 3 after the regrooving operation is equal to 9.5 mm and therefore represents 127% of H_{N3}.

This height H_{R} corresponds to a regrooving by 7.5 mm while 2 mm of the height of the initial groove still remains, and this value is close to the legal limit generally permitted, corresponding to the minimum height and to the height of the tread wear indicators. This limit is indicated by the line 7 in FIG. 5.

The height, that cannot be measured before this regrooving and that corresponds to the distance between the tread surface when new and the bottom of a groove 3 after the regrooving operation, is thus equal to 15 mm. The ratio of this non-measurable height, equal to 15 mm, to the height H_{N3} is equal to 2 and thus correctly greater than or equal to 200%.

The height H_{R}, measured after regrooving, and the height, that cannot be measured before regrooving and that corresponds to the distance between the tread surface when new and the bottom of a groove 3 after the regrooving operation, can also be determined on a new tire from the regrooving diagrams supplied by the manufacturer, as explained above.

FIG. 6 illustrates a tire the grooves 23 of which can be re-cut twice. The grooves 23 when new consist of two layers B and C forming the bottom of the grooves when new and corresponding to these two regrooving operations.

The height H_{N23} of the grooves 23 when the tire is new is equal to 6 mm.

The height H_{R1} of the grooves 23 after the first regrooving operation is equal to 7 mm and therefore represents 117% of H_{N23}.

This height H_{R1} corresponds to a regrooving by 5 mm while 2 mm of the height of the initial groove still remains, and this value is close to the legal limit generally permitted, corresponding to the minimum height and to the height of the tread wear indicators. This limit is indicated by the line 71 in FIG. 3.

The height, that cannot be measured before a first regrooving operation and that corresponds to the distance between the tread surface when new and the bottom of the groove after the first regrooving operation, is thus equal to 11 mm.

The height H_{R1}, measured after the first regrooving operation, and the height, that cannot be measured before a first regrooving operation and that corresponds to the distance between the tread surface when new and the bottom of the groove after the first regrooving operation, can also be determined on a new tire from the regrooving diagram supplied by the manufacturer, as explained above.

The height H_{R2} of the grooves 23 after the second regrooving operation is equal to 6 mm and therefore represents 100% of H_{N23}. And the height H_{R2} of the grooves 23 after the second regrooving operation represents 86% of H_{R1}.

This height H_{R2} corresponds to a regrooving by 4 mm while 2 mm of the height of the initial groove still remains, and this value is close to the legal limit generally permitted, corresponding to the minimum height. This limit is indicated by the line 72 in FIG. 2.

The height that cannot be measured before the two regrooving operations and that corresponds to the distance between the tread surface when new and the bottom of the grooves 23 after the second regrooving operation is thus equal to 15 mm. The ratio of this non-measurable height, equal to 15 mm, to the height H_{N23} is equal to 2.5 and thus correctly greater than or equal to 200%.

The height H_{R2}, measured after the second regrooving operation, and the height, that cannot be measured before the two regrooving operations and that corresponds to the distance between the tread surface when new and the bottom of the grooves after the second regrooving operation, can also be determined on a new tire from the regrooving diagrams supplied by the manufacturer, as explained above.

The tire thus depicted in FIG. 6 is anticipating two regrooving operations at different stages in the wearing of the tire. Advantageously according to the invention, the grooves are re-cut simultaneously in each regrooving step.

According to other variant embodiments of the invention, the re-cutting of the various grooves of a tire may be scheduled to be performed in a manner that is spread over time. According to these variant embodiments, the tire may comprise a proportion of these grooves that can be re-cut just once, and other grooves that can be re-cut multiple times. A tire could thus comprise a combination of grooves such as those illustrated in FIG. 5 and of grooves such as those illustrated in FIG. 6.

Tires were produced based on the elastomeric compound described hereinbelow by way of the compound of which the tread is formed.

| | Compound |
|---|---|
| NR | 80 |
| BR | 20 |
| N234 | 48 |
| 6PPD-1,3- | 3 |
| DIMETHYLBUTYL PHENYL | |
| PARAPHENYLENEDIAMINE | |
| ZnO | 3 |
| SULFUR | 1.5 |
| Accelerator (CBS) | 0.9 |

The values of the constituents are expressed in phr (parts by weight per hundred parts of elastomer (rubber)).

A reference tire R similar to the one in the figures was produced to a configuration corresponding to the conventional embodiments for a regroovable tire. It comprises a single regroovable layer at the bottom of the grooves such that the height of the grooves after regrooving is equal to 5 mm and represents 42% of the height of the grooves when new, which is itself equal to 12 mm. This height after regrooving, which is equal to 5 mm, corresponds to a regrooving by 3 mm while 2 mm of the height of the initial groove still remains, this value being close to the legal limit generally permitted, corresponding to the minimum height. The height, that cannot be measured before the regrooving operation and that corresponds to the distance between the tread surface when new and the bottom of the grooves after the regrooving operation, is thus equal to 15 mm.

As in the case of the tires according to the invention and as explained hereinabove, the height, measured after a first regrooving operation, and the height, that cannot be measured before the regrooving operation and that corresponds to the distance between the tread surface when new and the bottom of the grooves after the regrooving operation, can also be determined on a new tire from the regrooving diagrams supplied by the manufacturer.

The reference tire R also has sipes which are similar to those of the tires according to the invention and the height of which is identical to the height of the grooves when new, which is 12 mm.

Tires T1 and T2 conforming to the invention were produced.

Tire T1 conforms to that depicted in FIG. 5.

Tire T2 conforms to that depicted in FIG. 6.

Measurements of grip on wet ground were taken on each of the tires under identical running conditions in accordance with the ISO 15222 standard. The results of the measurements are given in the following table; a value of 100 being assigned to the tire R when new. Values higher than 100 express superior grip performance.

| | | After | After |
|---|---|---|---|
| | New | regrooving once | regrooving twice |
| Tire R | 100 | 96 | |
| Tire T1 | 100 | 100 | |
| Tire T2 | 98 | 100 | 100 |

These values show that, at all stages in the wearing of the tire, the properties in terms of grip on wet ground are maintained. The inventors think that the value of 96 for the reference tire after regrooving can be explained on the one hand by a tread pattern depth which is less overall and on the other hand by a sipe depth less than that of the grooves.

Furthermore, wearing tests were conducted to demonstrate substantially identical performance between the tires T1 and T2 according to the invention and the reference tire R. Specifically, the volume of elastomer materials constituting the tread and that can be worn away during the life of the tire and of the regrooving operation or operations is substantially the same for all three tires, leading to very similar values for the tire life. Tire life may be slightly superior for tires T1 and T2 in harsh-wear scenarios, and slightly inferior in what might be termed mild-wear scenarios, the difference in ranking being associated with the difference in tread stiffness, the depth of the grooves being of order one with reference to tread stiffness.

Rolling resistance measurements were also carried out on each of the tires under identical running conditions according to Regulation No 117 of the United Nations Economic Commission for Europe (UNECE). The results of the measurements are given in the following table; a value of 100 being assigned to the tire R when new. A value of 90 signifies that the coefficient of rolling resistance is reduced by 10% and corresponds to superior performance in terms of rolling resistance. Measurements were taken on a new tire and on a tire planed down to the usual wear limit of around 2 mm on each of the tires R, T1 and T2. Measurements were taken again after each of the tires R, T1 and T2 had been regrooved, and then further measurements were taken on each of the tires R, T1 and T2 when they had again been planed down to the usual wear limit of around 2 mm. Tire T2 is also measured after the second regrooving operation and a final measurement was taken on this tire T2 after it had been planed down to the usual wear limit of around 2 mm.

| | | | After | | After | |
|---|---|---|---|---|---|---|
| | | Wear | regrooving | Wear | regrooving | Wear |
| | New | limit | once | limit | twice | limit |
| Tire R | 100 | 68 | 72 | 62 | | |
| Tire T1 | 94 | 77 | 86 | 62 | | |
| Tire T2 | 92 | 80 | 86 | 70 | 75 | 62 |

FIG. 7 schematically illustrates how the rolling resistance of each of the tires R, T1 and T2 evolves from the as-new state to the end-of-life state, which is to say over the 13 mm of wear of the tread. In FIG. 3, the ordinate axis represents the measured or estimated value of the rolling resistance of the tire, as a function of the height of tread pattern worn away, and the abscissa axis represents this height starting from 0 and ending at 13 mm. The 13 mm correspond to the 15 mm of tread provided on each of the tires R, T1 and T2, accounting for the 2 mm kept at the end-of-life of the tires, this value being close to the legal limit generally permitted.

The three lines plotted in this FIG. 7 correspond to each of the tires R, T1 and T2. Calculating the areas bounded by these three plotted lines makes it possible to estimate the mean rolling resistance of each of these tires throughout their period of use. The results showed that tire T1 yields an improvement of 7% relative to tire R, and that tire T2 yields an improvement of 14% relative to tire R.

1.-11. (canceled)

12. A tire which can be regrooved at least once, comprising a crown reinforcement, the crown reinforcement radially capped by a tread, which is made of at least one elastomer compound and is joined to two beads via two sidewalls, the tread having at least one re-cuttable groove forming at least one tread pattern element making up a tread pattern of the tire, exhibiting a height H_{N3} between the bottom of the at least one re-cuttable groove and a tread surface when the tire is new, and at least one sipe, flush with the tread surface when the tire is new, exhibiting a height Hᵢ between the bottom of the at least one sipe and the tread surface when the tire is new,
wherein the height Hᵢ of the at least one sipe of the tire when new is greater than the height H_{N3} of the at least one re-cuttable groove of the tire when new, and
wherein, after a regrooving operation, a height H_{R} of at least one re-cut groove is greater than or equal to 70% of the height H_{N3} of the at least one re-cuttable groove of the tire when new.

13. The tire according to claim 12, wherein the height Hᵢ of the at least one sipe of the tire when new is greater than 90% of a height corresponding to a distance between the tread surface when new and the bottom of the at least one re-cuttable groove after a previous regrooving operation.

14. The tire according to claim 12, wherein the height Hᵢ of the at least one sipe of the tire when new is equal to a height corresponding to a distance between the tread surface when new and the bottom of the at least one re-cuttable groove after a previous regrooving operation.

15. The tire according to claim 12, wherein a height corresponding to a distance between the tread surface when new and the bottom of the at least one re-cuttable groove after a previous regrooving operation is greater than or equal to 200% of the height H_{N3} between the bottom of the at least one re-cuttable groove and the tread surface when the tire is new.

16. The tire according to claim 12, wherein the at least one re-cuttable groove is circumferential.

17. The tire according to claim 12, wherein the at least one re-cuttable groove is transverse.

18. The tire according to claim 12, wherein the at least one re-cuttable groove is oblique.

19. The tire according to claim 12, wherein the at least one re-cuttable groove can be re-cut at least twice.

20. The tire according to claim 19, wherein an elastomer compound regrooved during a first regrooving operation is different from an elastomer compound regrooved during a second regrooving operation.

21. The tire according to claim 12, wherein a regroovable elastomer compound is different from at least part of the at least one elastomer compound that constitutes the tread.

22. The tire according to claim 12, wherein the tread comprises, at least locally, at least two layers of elastomer compound radially superposed with one another in the tread.
